(19) United States
(12) Patent Application Publication
(10) Pub. No.: US 2026/0311454 A1
(43) Pub. Date: Oct. 8, 2026

(54) Image Classification System

(71) Applicant: Eric Winter Hess, Seatle, WA (US)

(72) Inventor: Eric Winter Hess, Seatle, WA (US)

(73) Assignee: Intelligent Computer Vision Group, LLC, Seattle, WA (US)

(21) Appl. No.: 19/171,997

(22) Filed: Apr. 7, 2025

(51) Int. Cl. G06V 10/764; G06T 7/20; G06T 7/62

(52) U.S. Cl. CPC G06V 10/764; G06T 7/20; G06T 7/62

(57) ABSTRACT

Described herein is an image classification system for a casino card game including one or more video camera for gathering image data of the card game, a processing unit for processing the image data received from the video cameras and analyzing the game play of the card game, and a user console for displaying the potential errors found by the error detection module, wherein a user can validate the potential errors as confirmed errors or misclassifications, and wherein the user console further includes a training module for storing confirmed errors by the user, to retrain the image classification system for a more accurate future classification. The processing unit further including an object classification module, a game play classification module, and an error detection module.

### CROSS-REFERENCE TO PRIOR APPLICATIONS

The present application claims priority and benefit of U.S. Provisional Patent Application No. 63/575,358 (filed Apr. 05, 2024), which application is incorporated by reference to the extent permitted by applicable law.

### FIELD OF THE INVENTION

The present invention relates to a casino game monitoring system, and more particularly to an image classification system that can analyze and classify motion paths, classify game objects, and analyze gameplay.

### BACKGROUND OF THE INVENTION

Numerous types of casino game monitoring systems have been used to track casino game play, detect cheating, and track dealer and player statistics. Traditional monitoring systems are designed using an optical scanner in the card shoe to either physically scan each card face that pass through the card shoe as it is dealt to a player, or detects coded markings that are nearly imperceptible to the human eye. While such systems are accurate in their image classification since a clear, consistent, and an unobstructed scan of each card is achieved; such devices do not comply with (and/or violate) live-play gaming regulations established and enforced by more than 380 local, state, and tribal Gaming Control Boards operating within the United States today. Therefore, whereas a shoe with embedded scanner requires technical compliance reviews and/or issuance of a formal waiver from each Gaming Control Board where it is to be deployed, an improved image classification system that can accurately and consistently classify game objects using only the card face, when it becomes visible to Players, Dealers and Observers within the progress of normal game play achieves utility and efficiency using only the card face when it becomes visible to Players, Dealers and the overhead surveillance cameras already mandated by Gaming Control Boards. hence complying with all known Gaming Control Board regulations.

### SUMMARY OF THE INVENTION

The present invention provides an image classification system for a casino card game comprising one or more video cameras for gathering image data of the card game, a processing unit for processing the image data, and a user console for displaying potential errors found by the error detection module. In some embodiments, the processing unit further comprises an object classification module for classifying the card game objects identified by the video cameras, a game play classification module for verifying the classification of the card game objects based on game play analytics, and an error detection module for identifying any potential errors in the object classification system. In some embodiments, the object classification module classifies card game objects based on suit, rank, pips, total card population, and game play parameters. In some embodiments, the game play classification module verifies classification of the card game objects based on game play analytics including card motion, dealer hand motion, game mechanics, card population, and total card count. In some embodiments, the error detection module identifies potential errors through comparisons of classifications between the object classification system and the game verification system for each game object in play. In some embodiments, the user console allows a user to validate any potential errors as confirmed errors or proper classifications. In some embodiments, the image classification module further comprises a training module for storing confirmed errors by the user, which will be used to retain the image classification system for a more accurate future classification.

In some embodiments, the number of video cameras for gathering image data depends on the card game being played on a game table, the size of the game table, and the number of players positions, including the dealer, that can play at the table. In some embodiments, the card characteristics classified by the object classification module include suit, rank, pips, total card population, and game play parameters. In some embodiments, the object classification module can identify and distinguish between gaming chips and playing cards. In some embodiments, the game play analytics includes card motion, dealer hand motion, game mechanics, card population, and card count. In some embodiments, the error detection module creates a reinterrogation list including the identified potential errors. In some embodiments, the reinterrogation list is displayed within the user console for reinterrogation of the identified potential errors. In some embodiments, the user console further displays game play analytics including individual player win rates, winnings, losings, total payouts, current card count, and player rank. In some embodiments, the user console includes a touch-screen display screen. In some embodiments, the training module utilizes artificial intelligence and machine learning to update the image classification module after a potential error is identified.

In another embodiment, a casino game monitoring system includes one or more video cameras for gathering image data of the casino game, a user console for processing the image data received from the one or more video cameras and analyzing the game play of the casino game. In some embodiments, the user console includes an object classification module for classifying the casino game objects identified by the video cameras, a game play classification module for determining values for the identified casino game objects based on a rule system for the casino game and for tracking the flow of the casino game, a motion detection system for tracking the motion of the identified objects from the object classification module, a verification module for identifying any errors that were created by the object classification module, the game play classification module, or the motion detection module, a reclassification module for correcting any of the identified errors from the verification module, a notification module for outputting an alert if an error has occurred during the casino game, and a user interface for outputting a list of potential errors in the casino game.

In some embodiments, the number of video cameras for gathering image data depends on the card game being played on a game table, the size of the game table, and the number of players positions, including the dealer, that can play at the table. In some embodiments, the user console includes a touch-screen display. In some embodiments, the touch-screen display of the user console further displays game play analytics including individual player win rates, winnings, losings, total payouts, current card count, and player rank. In some embodiments, the object classification module can identify and distinguish between gaming chips and playing cards, and more specifically where those objects are located, including the discard tray, shoe, and dealer's chip tray. In some embodiments, the object classification module classifies the playing cards based on one or more card characteristics, and wherein the card characteristics include suit, rank, pips, total card population, and game play parameters. In some embodiments, the game play classification module further determines values for the identified casino game objects based on game play analytics including card motion, dealer hand motion, game mechanics, card population, and card count. In some embodiments, the motion detection system further tracks a starting point and end point of travel of a playing card and chips. In some embodiments, the verification module compiles a reinterrogation list including any potential errors identified between the object classification module, game play classification module, and motion detection system. In some embodiments, the reclassification module utilizes artificial intelligence and machine learning to update the image classification module after a potential error is identified.

### BRIEF DESCRIPTION OF THE DRAWINGS

The features of the exemplary embodiments of the present invention will be described with reference to the following drawings, where like elements are labeled similarly, and in which:

FIG. 1 is a schematic view an image classification system according to the present disclosure;

FIG. 2 is a top-down view of a casino gaming table;

FIG. 3 is a flow chart of the processing unit shown in FIG. 1;

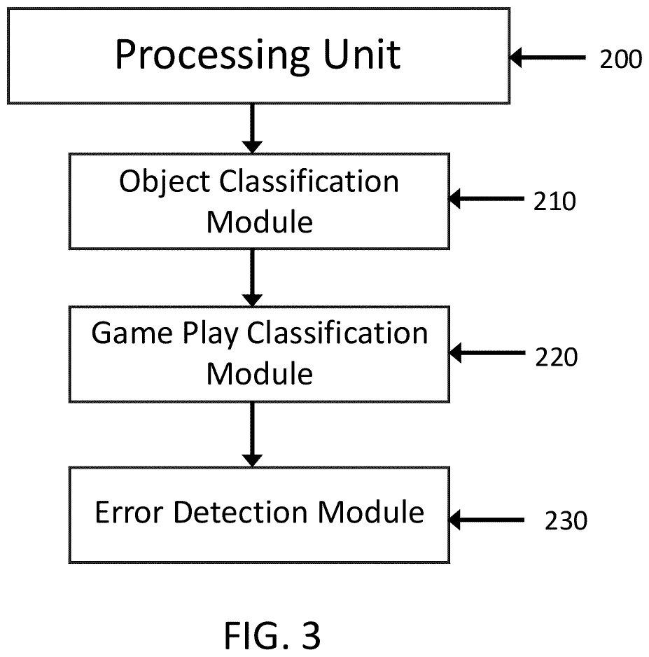

FIG. 4 is a flow chart of the object classification module shown in FIG. 3;

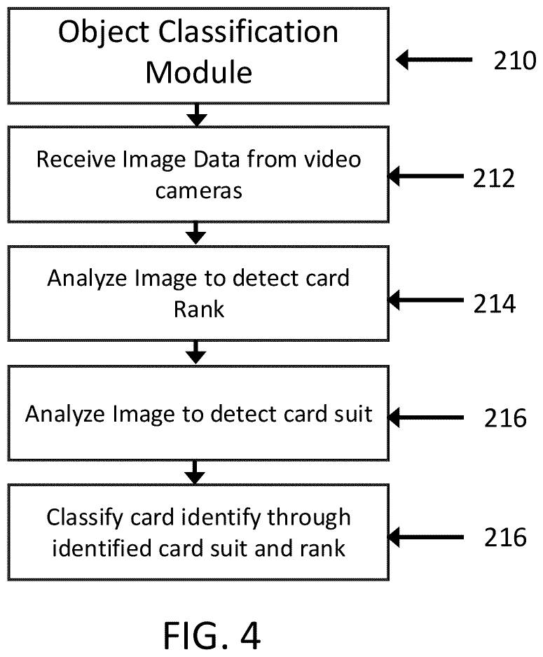

FIG. 5 is a flow chart of the game play classification module shown in FIG. 3; and

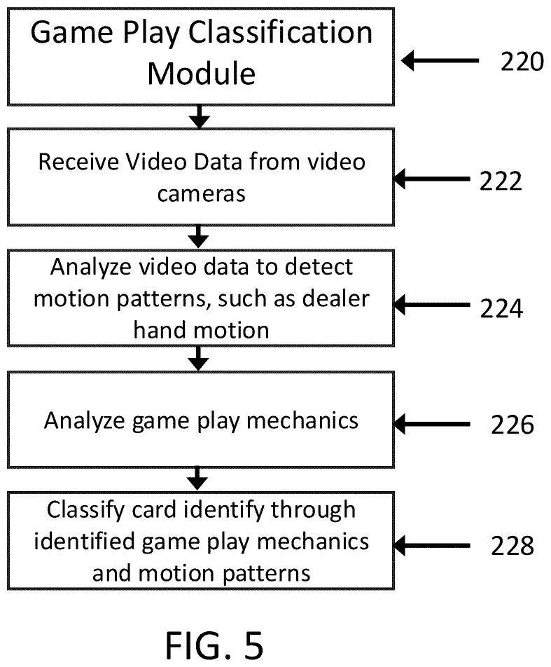

FIG. 6 is a flow chart of the error detection module and training module shown in FIG. 3.

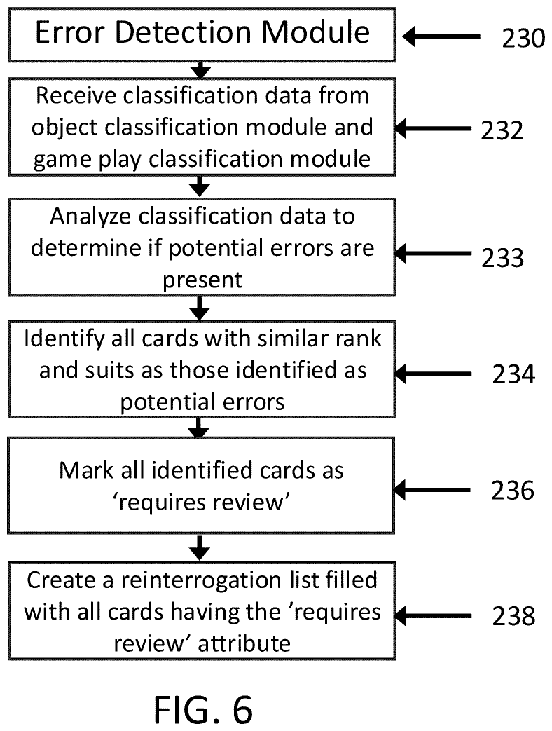

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

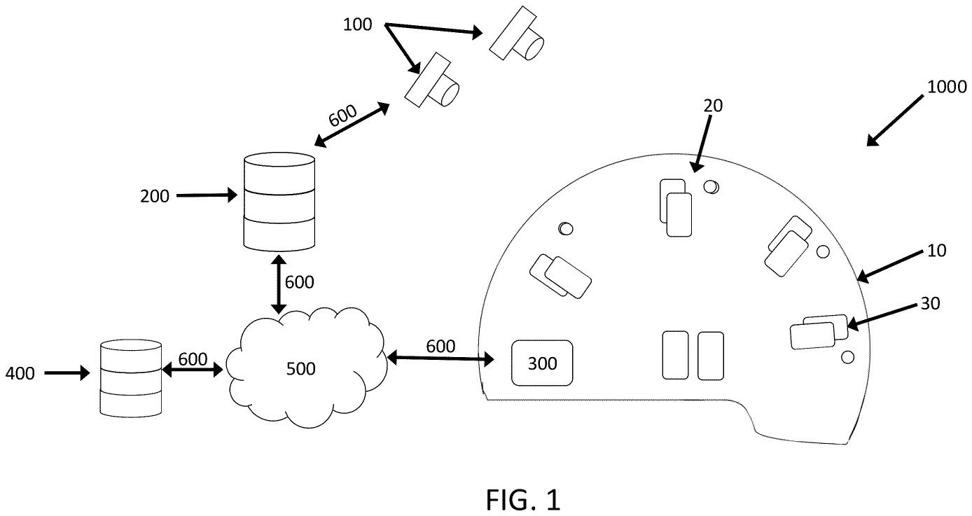

FIG. 1 depicts an exemplary embodiment of an image classification system 1000 for a casino card game according to the present disclosure. Unlike traditional casino security systems that include a card scanner within the card shoe to classify the cards, or an optical sensor to detect the nearly imperceptible coded markings on the card; the image classification system 1000 can accurately classify and identify the cards being used in the casino game in real-time, without the need of a card scanner. This allows the image classification system 1000 to meet casino gaming regulations where other card shoe scanners fail this regulation due to their gathering of card details prior to the card being shown to a player. Instead, the present disclosure gathers the card classification details in real-time, simultaneous with the player. Further, traditional computer vision systems classify the entire frame captured by video cameras; whereas the image classification system 1000 focuses on classifying multiple regions on the face of the playing card after the card has been detected and extracted from its background (i.e., cropped). The process of classifying multiple regions on the card face, and extracting the card image provides more useful data to casino operators such as detailing how the image classification system 1000 classifies a particular game object (e.g., the system 1000 detected an element and classified that element as the suit, and detected a numerical value and classified that value as the rank). The process, repeated on three regions of the card face (upper left, central, and lower right) compares the classification results and declares the card's rank and suit. The combination of video cameras 100, processing unit 200, user console 300, and training module 400 allows the present disclosure to properly and accurately classify the cards without the need of a card scanner.

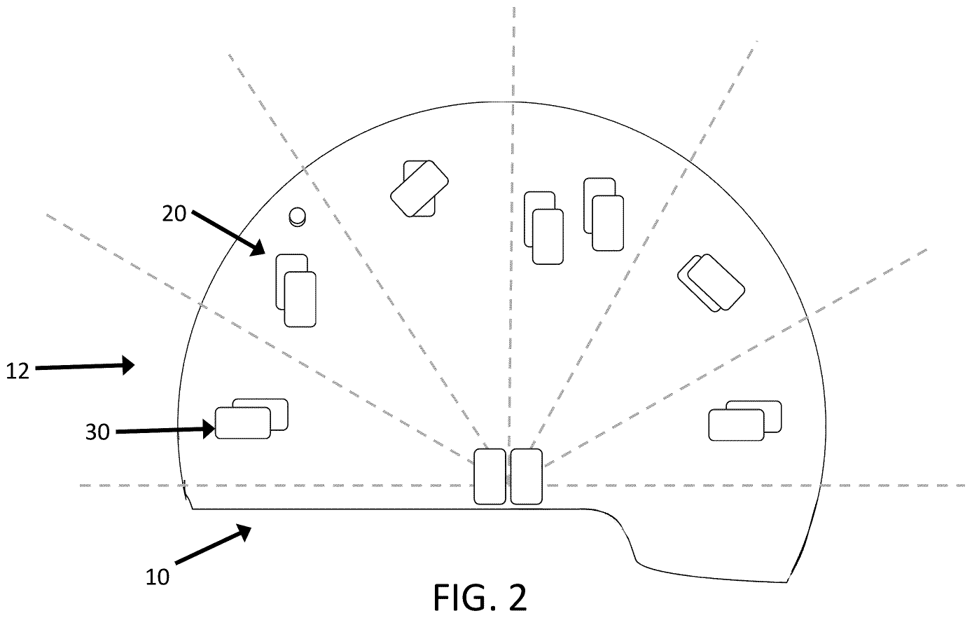

The image classification system 1000 identifies and classifies game objects 20 located on a casino table 10. Due to the shape of traditional casino tables 10, being round or circular, the image classification system 1000 utilizes a polar coordinate system (shown in FIG. 2) virtually overlayed onto the casino table 10 to segment the casino table into a plurality of sections 12, where each section denotes a player's play area, the dealer's play area, and betting areas. The polar coordinate system allows the image classification system 1000 to determine which casino game cards 30 are associated with each player at the casino table 10. Instead of using a traditional X, Y coordinate system of the video frame, the image classification system 1000 utilizes a polar coordinate system due to its increase in accuracy related to sectioning a player's area. This is primarily due to the play area for the dealers, players, and betting areas being sections of a round or circular casino table 10, and the cards 30 are dealt radially from the dealers' position. Further, a polar coordinate system allows for more accurate classifications due to the game play mechanics and betting during a game of blackjack since the game is played in a clockwise fashion. As such, the image classification system 1000 can detect the motion of the game cards 30 and their position along the polar coordinate system to determine which player the game card 30 was dealt to. The polar coordinate system allows the image classification system 1000 to track and accurately assign sequences of cards that are dealt to each individual player, even if the game cards 30 extend outside of that player's dedicated play area—such as when additional cards are dealt to the side of the player during a split. For example, if player 1 is dealt matching cards, which signifies the hand is eligible for a split, the image classification system 1000 will first detect that the motion of each dealt card originated from the dealer's position and terminated at the player 1's position (i.e., within that player 1's section of the polar coordinate system). The image classification system 1000 would then detect the card motion signifying a split, thus separating player 1's initially dealt hand into two separate hands. Now, even if the newly separated hands are positioned outside of the polar coordinate region for player 1, the image classification system 1000 will still recognize that those cards belong to player 1 as they originated in player 1's region initially.

To monitor the casino table 10 and the cards being dealt, the image classification system 1000 utilizes a plurality of video cameras 100. In some embodiments, the image classification system utilizes one camera 100 for each player and dealer that the casino table 10 is designed to host. In some embodiments, the video cameras 100 record the gameplay on the casino table 10 and transmit the recording to a database 500 which can be later viewed by a casino official. In some embodiments, the video cameras 100 livestream the gameplay that is occurring on the casino table 10. In some embodiments, the video cameras are hardwired to the casino's servers and databases to be monitored at their central system. In other embodiments, the video cameras 100 monitor the gameplay and store the gameplay onto the user console 300 for a casino official to review. In some embodiments, the cameras 100 are existing security cameras within casino establishments. In some embodiments, the video cameras 100 are additional security cameras mounted above and around the casino table 10 for a clear view of the cards 30 being placed on the casino table 10.

The video cameras 100 are linked together and the image data received by the video cameras 100 are sent to the processing unit 200 for processing the data and analyzing the game play of the card game. The processing unit 200 identifies and classifies the cards being dealt in real time. The processing unit 200 further includes an object classification module 210 to classify the objects identified by the video cameras 100, a game play classification module 220 to create a second classification check for the objects classified by the object classification module 210 through means related to the game play occurring on the casino table 10, and an error detection module 230 for identifying any potential errors in the object classification module 210 and game play classification module 220, and compiling a list of potential errors to be reinterrogated and reclassified by the user.

As briefly described above, the object classification module 210 classifies the card game objects 20 identified by the video cameras. In some embodiments, the card game objects 20 are playing cards 30. In some embodiments, the playing cards 30 are classified based their suit, rank, pips, and total card population. For example, in a standard card game of blackjack, the cards are one of four suits: hearts, diamonds, spades, and clubs. Further, the cards are ranked, or numbered two through ten, and also include an ace, king, queen, and jack. Further, each playing card 30 includes pips on the face of the card, the pips help to further identify the suit and rank of the card. For example, a four of diamonds card will have four diamond-shaped pips located on the center of the face of the card 30. Moreover, each of the playing cards will have a number and suit symbol in the top left and bottom right of the card to further identify the card (e.g. 4 and a diamond-shaped symbol). A standard deck of cards includes 52 cards which breaks down into a full set of 13 cards per suit: ace, one, two, three, four, five, six, seven, eight, nine, ten, jack, queen, and king. A standard card shoe for a game of blackjack will typically contain multiple decks, with the exact number of decks being used ranging based on the casino's preference, and the shoe will also contain one or more cut cards which are unmarked cards having solid colors that signify the last cards to be dealt from the shoe.

The object classification module considers each of these elements of the playing card 30 to confirm and classify the playing cards 30 that are present on the casino table 10 at any given moment during the casino game. For example, if a four of diamonds is faceup on the casino table, the object classification module will look in the top and bottom corner of the card to find the rank and suit of the card, in this example the module 210 would observe a number 4 with a diamond-shaped symbol, this would be an initial classification. The module 210 would then compare that initial classification of four of diamonds to the database 500 to obtain the other attributes that belong to a four of diamonds card, e.g. the pips should show four diamond-shaped symbols on the center of the face of the card, and the module 210 will confirm that a four of diamonds has not been already identified by the module during the present game since each deck will only have one four of diamonds. In some embodiments, the casino game will utilize multiple decks of cards. As such, the module 210 will track the total population of each card (i.e., number of decks will equal the population for each playing card). In some embodiments, only a portion of the playing card 30 will be visible by the cameras 100, such as when a card is overlapped with another card. As such, the object classification module 210 will be able to extrapolate the pip, rank, and suit through the visible elements described above to create a confidence interval to successfully identify the playing card 30. For example, if a four of diamonds card is positioned such that only a top portion of the card is visible, the module 210 will view the visible corner of the card to obtain the initial classification. The initial classification will then be compared to the database to obtain additional elements and identification markers to verify the classification, e.g. the card should also include four diamond-shaped pips in the center of the face of the card. The identification module would then analyze the card to search for the pip pattern. However, in the example where only a portion of the card is visible, the identification module 210 would analyze the visible pattern and configuration of the visible pips to complete the full pip pattern, and to properly identify the card based on the pips. This result would then be compared to the total card population for the four of diamonds to verify that a four of diamonds is still available to be identified.

As will be described further below in a sample game of blackjack, once the rank and suit are determined for each card on the playing area of the casino table 10, the data is stored in the active game log. The active game log is a temporary storage for all cards dealt during the full card shoe. The active game log is utilized by the error detection module 230 to create the list of potential classification errors to be displayed to the user. Once a complete card shoe is dealt, the active game log will clear, thus signifying a new game is starting.

In addition to classifying the cards 30 based on the card attributes (rank, suit, pip, card population), the image classification system 1000 also classifies the cards through the game play classification module 220, which verifies the classification of the cards based on game play analytics. The game play analytics include card motion, card orientation and position, dealer hand motion, game mechanics, and card count. For example, the game play classification module analyzes the path of a card during a hand of black jack, if for example a player is dealt two cards with the same ranks (two tens), the player can split the dealt hand into two separate hands. The game play classification module 220 will detect the split motion and classify the two split cards as having the same rank (i.e. both cards are tens). This motion detection will be used by the game play classification module 220 to verify the classification from the object classification module 210. Another example of the game play classification module 220 includes the dealer's hand motion. For example, if the dealer continues to deal out cards to the same player, the game play classification module 220 will detect that the sum of the cards for that player's hand is less than 21 since a player cannot hit if their hand exceeds 21. Further, the game play classification module 220 tracks the count for the game, which can be used by the casino for cheat detection systems. Moreover, the game play classification module 220 checks the total card population for each identified card to ensure that the identified card is still available in the deck prior to its identification. Further, the game play classification module 220 compares the classifications between the object classification module 210 and the game play verification module 220 for each game object 20 in play. If the game play classification module detects an inconsistency between the classification between its module 220 and the classification from the object classification module 210, a potential error will be flagged and reviewed by the error detection module 230.

The error detection module 230 retrieves all data relating to all cards flagged as potential errors by the game play classification module 220. In some embodiments, the error detection module 230 accesses the game log data previously generated by the object classification module and game play classification module. The error detection module 230 then analyzes the data within the game log to screen for potential errors. For example, if a player was dealt two tens but the object classification module 210 classified the hand as a nine and ten and the game play classification module 220 detected a split (which would signify that both cards had the same rank); the game play classification module 220 would flag this as a potential error, and the error detection module 230 would detect an error in the classifications and flag the cards as a potential error needing review. The error detection module 230 will create a reinterrogation list by looking up card IDs for all other cards having the same declared rank and suit as each of the cards identified by the game play classification module 220 as being a potential error. Once all cards have been identified, the error detection module 230 will add an attribute ‘requires review’ to each of the identified card IDs, thus signaling to the user that reinterrogation is needed on each of the identified cards as a potential error may be present. In some embodiments, the error detection module 230 logs all data generated by the system using a logging shorthand format. The logs generated by the error detection module 230 are then used to for re-examination and reevaluation later on in the system by the training module 400, or even by the user to go over an potential incidents that may have occurred throughout the night at the gaming table.

In another example, the error detection module 230 can use total card population to detect a classification error. In this example, the shoe utilizes four decks of cards, and the object classification module 210 has identified 53 cards having a suit of clubs. The error detection module 230, will flag the 53 cards classified as clubs as a potential error because in a 4-deck shoe, there is only 52 cards that are of the club suit. Further, the error detection module 230 will add each of the identified cards to the reinterrogation list and add the attribute ‘requires review’ to each of the identified card IDs, thus signifying to the user that reinterrogation is needed on each of the identified cards since at least one of those cards is described as having an incorrect suit. In some embodiments, the image classification system 1000 can self-remedy errors found by the error detection module without the need of user intervention. For example, this can be accomplished by reanalyzing each of the identified cards now with the perspective of the potential error (i.e., the suit of the card). The analysis can be completed on each of the identified cards, and if the true error is detected, the system 1000 will update the classification of the error card and remove the attributes of ‘needs review’ from each of the recently labeled cards from the interrogation list.

Any detected errors will be recorded into a list of errors to be reviewed and properly classified by a user. Once properly classified, the reclassified list will be used by the training module 400 for more accurate future classifications by the image classification system 1000.

The image classification system 1000 further includes a user console 300 for displaying the potential errors found by the error detection module 230, displaying game play analytics, providing an interface for a user to properly validate the potential errors as confirmed errors or misclassifications. In some embodiments, the game play analytics displayed by the user console 300 include individual player win rates, winnings, losings, total payouts, current card count, and player rank. In some embodiments, the user console 300 is a touch screen display that can be utilized by the dealers and gaming integrity staff to toggle displays, check player statistics, check game play analytics, and resolve any pending errors presented by the error detection module 230. In some embodiments, the user console 300 is a display screen that displays player statistics, game play analytics, and pending errors from the error detection module 230.

For example, in some embodiments, the user console 300 will display a list of the identified cards with the attribute ‘requires review’. This will prompt the user that potential errors exist and require reclassification. The user will then resolve the errors and identify whether the error was a true error and whether the error was due to misclassification in rank, suit, shoe, dealer ID, table position, and origin of the card. The updated attributes will be stored with the training module 400 for future classification trainings. For example, if the image classification system 1000 repeatedly finds an error with a particular rank, suit, etc, the system 1000 can be further trained to more accurately classify the card. After all hands have been dealt, and both cut cards are displayed, the status of the table will switch back to open, signaling that a new game will begin. As more games are recorded and observed by the image classification system 1000, the accuracy of the system will begin to increase due the training module 400 learning from previous misclassifications as described above.

As previously described, the training module 400 utilizes previous mistakes to increase the accuracy of the system 1000 over time. For example, as more misclassifications are identified, and resolved/reclassified, the data from those misclassifications will be sent to the training module 400 and consolidated as a new labeled data set for training. In some embodiments, the training module 400 utilizes machine learning artificial intelligence for additional pattern recognition and training. The newly learned patterns identified by previous misclassifications will help to prevent future misclassifications, thus minimizing the potential of unique future misclassifications. Eventually, the system 1000 will reach a point where training module 400 has trained the system 1000 to have confidence scores for both rank and suit for each card that rivals the accuracy of a shoe card scanner. In some embodiments, the training is done fully within the training module 400. In other embodiments, the training module can incorporate one or more third party APIs for executing one or more training sequences to generate new object classifications based on the trained data.

An example game of blackjack utilizing the image classification system 1000 of the present disclosure includes the following steps: First, the user console 300 will display that the status of the table is open, meaning that a game has not begun yet. In this status, the memory for the active game database should be cleared. Once the dealer deals at least one card to any player position, one card to the dealer position, the status of the table will change to “Game in Play”, generating a unique shoe ID which includes date, time, and table ID for the new game. The cameras 100 will monitor the following positions for motion including the shoe position, player's table position, dealer's table position, discard tray position. When motion is recognized in any of these positions, the system 1000 will check to see if a motion path has begun in one position, ended in another position, and if a card was detected as being placed down on the table, i.e. dealt. When a card has been detected at the end of a motion path, the card image shall be extracted and normalized by the cameras 100 and processing unit 200. This image data is then analyzed by the object classification module 210 to log the following data: unique card image ID for each of the playing cards, data and time card was dealt, card motion path (polar coordinates of the start and end motion path and of the table positions, along with named game play regions-player 1, player 2, dealer, discard pile, etc.), card sequence (the card sequence that it was dealt during a shoe), card hand number (the running count of hands played during the current shoe), card face position (face up or face down), card suit, suit confidence, card rank, rank confidence, current running table count value, current true table count value. To gather all of the above information for each of the dealt cards, the object classification module 210 will first detect the whether or not the card origin was the card shoe and the destination was a player position or a dealer position. Once confirmed, the object classification module 210 will then determine if the dealt card is faceup or face down. If face up, the object classification module 210 will detect the shape and color of pips in the visible corners (upper left and lower right corner) of the dealt card. The object classification module 210 will then detect the pattern of the pips located in the center of the faceup dealt card, to obtain a second measurement of the card rank and suit. Further, if fully visible, the object classification module 210 will also observe the total number of pips in the center of the faceup dealt card to obtain a third measurement of the card rank and suit. In some embodiments, the object classification module 210 will include optical character recognition to detect the rank and suit of the face up dealt card, this obtained value will be compared to all allowable values for a card rank and suit (e.g. A, 1, 2, 3, 4, 5, 6, 7, 8, 9, 10, J, Q, K, diamond, spade, hearts, and clubs).

After obtaining all measurements, the object classification module 210 will compare the results of the full card classification and then compare those identifications to the segmented rank, pip count, and pip pattern to determine the card rank; and then to repeat this process to determine card suit. In some embodiments, it will also check to see if the full compliment of that card's rank and suit has already been classified in the game. This process will repeat for each dealt card and every image of every dealt card will be logged and retained by the active game play memory to be transferred to the training module 400 for future training if a potential error is detected. In some embodiments, the processing unit 200 will also use the card's rank to retrieve the corresponding count value depending on the table's card counting strategy. In some embodiments, the table's running count will be displayed on the user console 300 for the surveillance operators to observe, and the count will be updated in real-time as each new card is dealt.

Following the object classification module 210, the game play classification module 220 will analyze card motion, dealer hand motion, game mechanics, and card count to verify that the classification from the object classification module 210 falls within acceptable game play options. For example, in the scenario where a player was dealt two identical cards and split their hand, the object classification module should classify the ranks of both cards as the same values, and the game play classification module 220 should detect the cards as being sequentially dealt cards to the player, the cards being originally overlapping (signifying a player's dealt hand), and a dealer hand motion signifying a split of the cards such that the player has two hands (with each hand having one of the originally dealt cards); thus further signifying that the two cards have at least the same rank and were split. Further, the game play classification module 220 performs a count of how many instances of each card type (suit and rank) have been played from that shoe. If the count of the card exceeds the number of decks in the shoe, the module 220 will flag the card as a potential error.

Moreover, the game play classification module 220 will check the table coordinates, player position, hand number, card face and rank to observe the range of possible player decisions: stay, split, double down, bust, or push. If the game play classification module 220 detects any potential errors or discrepancies with the classifications, it will mark those cards as a potential error to be called by the error detection module 230 for reinterrogation.

The error detection module 230 will then begin to create a reinterrogation list to be displayed to the user. The error detection module 230 will create the reinterrogation list by looking up card IDs for all other cards having the same declared rank and suit as each of the cards identified by the game play classification module 220 as being a potential error. Once identified all cards have been identified, the error detection module 230 will add an attribute ‘requires review’ to each of the identified card IDs, thus signaling to the user that reinterrogation is needed on each of the identified cards as a potential error may be present.

The user console 300 will display the identified cards with the attribute ‘requires review’, thus displaying to the user any potential errors that require reclassification. The user will then resolve the errors and identify whether the error was a true error and whether the error was due to misclassification in rank, suit, shoe, dealer ID, etc. The updated attributes will be stored with the training module 400 for future classification trainings. For example, if the image classification system 1000 repeatedly finds an error with a particular rank, suit, etc., the system 1000 can be further trained to more accurately classify the card. After sufficient hands have been dealt, the shoe will reach the first of two cut cards. The first cut card signals that the current hand being played by all players will be the final hand dealt from the shoe. At the conclusion of that hand/round of play, the placement of a second cut card on the table, or the clearing of the table of all cards, signals the end of play for the current shoe. At this time all game play metrics and images related to the play of that shoe are saved to file for later review if required, and all game data (total card populations, card sequences, dealer and player hands, etc.) will be reset. As more games are recorded and observed by the image classification system 1000, the accuracy of the system will begin to increase due the training data consolidated by training module 400, and the subsequent learning from previous misclassifications errors that have been resolved within the error detection module as described above.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. An image classification system for a casino card game comprising:
one or more video cameras for gathering image data of the card game;
a processing unit for processing the image data received from the one or more video cameras and analyzing the game play of the card game, wherein the processing unit comprises:
an object classification module for classifying the card game objects identified by the video cameras, and wherein the object classification module generates image classification data for each card game object based on one or more card characteristics,
a game play classification module for verifying the classification of the card game objects based on game play analytics, and
an error detection module for identifying any potential errors in the object classification module, wherein the error detection module identifies the potential errors through comparisons of classifications between the object classification module and the game play classification module for each game object in play; and
a user console for displaying the potential errors found by the error detection module, wherein a user can validate the potential errors as confirmed errors or proper classifications, and wherein the user console further comprises a training module for storing confirmed errors by the user, wherein the stored confirmed errors are used by a training module to retrain the image classification module for a more accurate future classification.

2. The image classification system of claim 1, wherein the number of video cameras for gathering image data depends on the card game being played on a game table, the size of the game table, and the number of players positions, including the dealer, that can play at the table.

3. The image classification system of claim 1, wherein the card characteristics classified by the object classification module include suit, rank, pips, total card population, and game play parameters.

4. The image classification system of claim 1, wherein the object classification module can identify and distinguish between gaming chips and playing cards.

5. The image classification system of claim 1, wherein the game play analytics includes card motion, dealer hand motion, game mechanics, card population, and card count.

6. The image classification system of claim 1, wherein the error detection module creates a reinterrogation list including the identified potential errors.

7. The image classification system of claim 6, wherein the reinterrogation list is displayed within the user console for reinterrogation of the identified potential errors.

8. The image classification system of claim 1, wherein the user console further displays game play analytics including individual player win rates, true card count, and current card count.

9. The image classification system of claim 1, wherein the object classification module stores all image identification data within a game log, and wherein the game log is accessible by the error detection module and one or more third party analytic packages.

10. The image classification system of claim 1, wherein the training module utilizes artificial intelligence and machine learning to update the image classification module after a potential error is identified.

11. A casino game monitoring system comprising:
one or more video cameras for gathering image data of the casino game;
a user console for processing the image data received from the one or more video cameras and analyzing the game play of the casino game, wherein the user console comprises:
an object classification module for classifying the casino game objects identified by the video cameras;
a game play classification module for determining values for the identified casino game objects based on a rule system for the casino game and for tracking the flow of the casino game;
a motion detection system for tracking the motion of the identified objects from the object classification module;
an error detection module for identifying any errors that were created by the object classification module, the game play classification module, or the motion detection module;
a reclassification module for correcting any of the identified errors from the verification module;
a notification module for outputting an alert if an error has occurred during the casino game; and
a user interface for outputting a list of potential errors in the casino game.

12. The casino game monitoring system of claim 11, wherein the number of video cameras for gathering image data depends on the card game being played on a game table, the size of the game table, and the number of players positions, including the dealer, that can play at the table.

13. The casino game monitoring system of claim 11, wherein the user console includes a touch-screen display.

14. The casino game monitoring system of claim 13, wherein the touch-screen display of the user console further displays game play analytics including individual player win rates, winnings, losings, total payouts, current card count, and player rank.

15. The casino game monitoring system of claim 11, wherein the object classification module can identify and distinguish between gaming chips and playing cards.

16. The casino game monitoring system of claim 15, wherein the object classification module classifies the playing cards based on one or more card characteristics, and wherein the card characteristics include suit, rank, pips, total card population, and game play parameters.

17. The casino game monitoring system of claim 11, wherein the game play classification module further determines values for the identified casino game objects based on game play analytics including card motion, dealer hand motion, game mechanics, card population, and card count.

18. The casino game monitoring system of claim 11, wherein the motion detection system further tracks a starting point and end point of travel of a playing card.

19. The casino game monitoring system of claim 11, wherein the verification module compiles a reinterrogation list including any potential errors identified between the object classification module, game play classification module, and motion detection system.

20. The casino game monitoring system of claim 1, wherein the reclassification module utilizes artificial intelligence and machine learning to update the image classification module after a potential error is identified.
